(19) United States
(12) Patent Application Publication
(10) Pub. No.: US 2024/0028892 A1
(43) Pub. Date: Jan. 25, 2024

(54) METHOD AND DEVICE FOR TRAINING A CLASSIFIER FOR MOLECULAR BIOLOGICAL EXAMINATIONS

(71) Applicant: Robert Bosch GmbH, Stuttgart (DE)

(72) Inventors: Jan Hendrik Metzen, Boeblingen (DE); Jeremy Zieg Kolter, Pittsburgh, PA (US); Nicole Ying Finnie, Renningen (DE)

(21) Appl. No.: 18/257,343

(22) PCT Filed: Dec. 10, 2021
(86) PCT No.: PCT/EP2021/085187

§ 371 Date: Jul. 6, 2023

(30) Foreign Application Priority Data
Dec. 14, 2020 (DE) 10 2020 215 815.0

(51) Int. Cl. G06N 3/08

(52) U.S. Cl. CPC G06N 3/08

(57) ABSTRACT

A computer-implemented method for training a classifier. The method includes: ascertaining a first input signal characterizing a plurality of evaluation points of a molecular biological examination system, and a desired output signal characterizing a classification of the evaluation points is allocated to the first input signal; subdividing the first input signal into a plurality of second input signals according to an arrangement of the evaluation points; ascertaining a plurality of first representations, a first representation being ascertained for each second input signal of a first subset of the plurality of second input signals using the classifier; ascertaining an output signal using the classifier and based on the plurality of first representations, the output signal characterizing a classification of the first input signal; adapting at least one parameter of the classifier according to a loss value which characterizes a difference between the ascertained output signal and the desired output signal.

### FIELD

The present invention relates to a method for training a classifier, a method for classifying with the aid of a trained classifier, a training device, a system for data processing, a computer program, and a machine-readable memory medium.

### BACKGROUND INFORMATION

German Patent Application No. DE 10 2016 222 075 A1 describes a method for processing a cartridge, in particular a microfluidic cartridge, and a biological sample held in the cartridge, with the aid of a processing unit.

### SUMMARY

In automated analytical systems such as in lab-on-a-chip systems for an in-vitro diagnosis, high demands are made on the correctness of the results of the analytical systems. In particular in cases where such an analytical system is used for medical tests of biological samples of human origin, e.g., with regard to infectious diseases, it is expected that the results satisfy the highest demands in terms of sensitivity and specificity.

An advantage of the method having the features of the present invention is that a classifier which has a higher classification accuracy with regard to a medical test result is able to be ascertained. For that reason, the classifier is advantageously able to improve the testing accuracy of a medical analytical device.

In a first aspect, the present invention relates to a computer-implemented method for training a classifier. According to an example embodiment of the present invention, the method includes the steps:
Ascertaining at least one first input signal, the first input signal characterizing a plurality of evaluation points of a molecular biological examination system, and a desired output signal, which characterizes a classification of the evaluation points, is allocated to the first input signal;
Subdividing the first input signal into a plurality of second input signals according to an arrangement of the evaluation points;
Ascertaining a plurality of first representations, a first representation being ascertained for each second input signal of at least a first subset of the plurality of second input signals, with the aid of the classifier;
Ascertaining an output signal with the aid of the classifier and based on the plurality of first representations, the output signal characterizing a classification of the first input signal;
Adapting at least one parameter of the classifier according to a loss value, the loss value characterizing a difference between the ascertained output signal and the desired output signal.

According to an example embodiment of the present invention, the evaluation points may particularly be evaluation points of a laboratory on a chip (lab-on-a-chip system), which evaluate a biological sample such as a blood sample, a urine sample, a saliva sample, or a sample from a swab, in particular with regard to the presence of at least one pathogen such as at least one virus and/or at least one bacterium, and/or at least one fungus in the sample. The method may be understood as training the classifier in such a way that it ascertains a classification on the basis of the evaluation points. The classification may specifically characterize whether or not the at least one pathogen is present in the sample or at which likelihood the at least one pathogen is present in the sample, and/or at which likelihood the at least one pathogen is not present in the sample.

Moreover, the present method may be understood in such a way that, for the training, a presence or absence of the at least one pathogen is indicated to the classifier with the aid of the desired output signal. After the training, the classifier is able to ascertain for a new sample whether or not the at least one pathogen is present in the new sample based on a new plurality of evaluation points.

According to an example embodiment of the present invention, the lab-on-a-chip system may particularly include a microarray. A microarray may be understood as an analytical system which allows for the parallel analysis of multiple, especially ten or several hundred or up to a thousand individual proofs in a small quantity of biological sample material. Different types of microarrays exist, which are also known as gene chips or biochips insofar as—similar to a computer chip—they may include a significant amount of information on the smallest space.

According to an example embodiment of the present invention, the microarray may particularly have a plurality of evaluation points to which the sample may be applied. Especially reagents, e.g., certain proteins, may be applied to the evaluation points, which lead to a biochemical reaction when applied to the sample and make possible to provide proof of the at least one pathogen. More specifically, the biochemical reactions may cause the emission of an electromagnetic radiation at the corresponding positions of the evaluation points of the microarray based on a chemiluminescence. It is also possible that electromagnetic radiation is emitted by fluorescence at the corresponding positions after a corresponding biochemical reaction.

Regardless of whether the electromagnetic radiation is generated based on chemiluminescence or fluorescence, the generated electromagnetic radiation can be measured with the aid of an optoelectronic sensor, in particular a camera, and provided in the form of an image, for example. Since the evaluation points emit electromagnetic radiation of different magnitudes as a function of the reagents and a presence or absence of the at least one pathogen, an image which is characteristic of the sample is created. Evaluation points imaged in the image may have different brightness levels, in particular.

The image may especially be used as a first input signal. As an alternative, it is also possible that the image initially passes through one or multiple preprocessing step(s), in particular from the field of computer vision, before it is made available as an input signal.

According to an example embodiment of the present invention, certain parts of the input signal may be understood as belonging to individual evaluation points. For example, certain regions of the image may be allocated to individual evaluation points in each case. The image may especially be broken down into a plurality of second images as a function of the position of the evaluation points, a respective second image representing only one evaluation point. The second images may be understood as the second input signals in this context. The evaluation points are preferably arranged in a grid, and the image is subdivided into the plurality of second images in accordance with the grid.

An advantage of subdividing the first input signal into the plurality of second input signals is that each evaluation point is thereby able to be individually evaluated by the classifier. In particular, a first representation, which may be understood as characterizing the evaluation point, can be ascertained for each evaluation point in this way. The first representations may be present in the form of a vector, a matrix, or a tensor and include values that characterize the content of the respective second input signal. The first representations are preferably able to be ascertained with the aid of a machine-learning method.

To their surprise, the inventors were able to discover that the ascertaining of the output signal based on the plurality of first representations allows for a much more accurate classification of the classifier.

As an alternative, it is also possible that no first representation is ascertained for at least one second input signal. This is advantageous in particular in cases where certain evaluation points are used for a purpose other than analyzing the sample. For instance, an evaluation point may simply be used to indicate whether a sample has been applied to the evaluation points in the first place. In this example, the evaluation point does not contribute to the classification of the presence or absence of at least one pathogen within the sample and may therefore be disregarded by the classifier.

In one preferred embodiment of the method according to the present invention, the classifier may include at least one first neural network by which the first representations are ascertained.

An advantage of the at least one first neural network is that neural networks are particularly suited to ascertaining meaningful representations from data. By ascertaining meaningful representations, the ascertainment of the classification is considerably simplified so that a classification accuracy of the classifier, that is, a capability of correctly predicting whether or not the at least one pathogen is present in the sample, is increased.

In one preferred embodiment of the present invention, the classifier includes a plurality of first neural networks, the classifier including a first neural network for a second input signal of the first subset in each case, with whose aid the first representation of the second input signal is ascertained.

This may mean that the classifier includes a first neural network for an evaluation point in each case, the first neural network learning during the training to learn the characteristic properties of the second input signals that indicate the evaluation point in each case. The first neural network may be seen as corresponding to the evaluation point. The first neural network is specialized in the evaluation point, so to speak. The advantage of this approach is that each first neural network is able to focus on the evaluation point that corresponds to it or on the second input signals that show the corresponding evaluation point. This simplifies the learning task, i.e., the ability to ascertain meaningful first representations from the first input signal, based on which a precise classification may then be ascertained, which leads to a more accurate classification of the classifier.

In the training method according to an example embodiment of the present invention, especially a plurality of weights of the respective first neural networks and/or a plurality of second weights of the second neural network may be understood as parameters.

In addition, it is possible that the output signal is ascertained with the aid of a second neural network encompassed by the classifier and based on the first representations.

The inventors were able to determine that the use of a second neural network leads to a further increase in the classification accuracy. The combination of first neural networks and second neural networks may also be understood as a total neural network, the total neural network first routing the plurality of second input signals on separate paths through the total neural network (that is, the respective first neural networks) and then merging the information of these paths (that is, with the aid of the second neural network) in order to then ascertain the output signal.

In addition, the present invention relates to a computer-implemented method for ascertaining an output signal which characterizes a classification of a first input signal, the first input signal characterizing a plurality of evaluation points of a molecular biological examination system, and the method including the following steps:
Training a classifier according to one of the afore-described aspects and/or embodiments;
Subdividing the first input signal into a plurality of second input signals according to an arrangement of the plurality of evaluation points;
Ascertaining the output signal based on the plurality of second input signals with the aid of the classifier.

According to an example embodiment of the present invention, the method for ascertaining the output signal may be understood as an inference by the classifier which has previously been trained with the aid of an embodiment of the training method. The method for ascertaining the output signal thus derives its advantages, i.e., an improved classification accuracy of the classifier, from the training method.

It is preferably also possible to actuate a display device based on the ascertained output signal in such a way that the display device suitably displays the classification.

For example, it is possible that the result of the classification is displayed on a display of the display device. If the output signal characterizes a classification of a presence of at least one pathogen, it is alternatively or additionally possible for the display device to output an acoustic signal such as with the aid of a loudspeaker.

In the following text, example embodiments of the present invention are described in greater detail with reference to the figures.

### BRIEF DESCRIPTION OF THE DRAWINGS

FIG. 1 shows schematically, a structure of a classifier for the classification of evaluation points of a molecular biological examination system, according to an example embodiment of the present invention.

FIG. 2 schematically, a training system for training the classifier according to an example embodiment of the present invention.

FIG. 3 schematically, a control system to control a molecular biological examination system according to an example embodiment of the present invention.

FIG. 4 schematically, an exemplary embodiment of a molecular biological examination system of the present invention.

### DETAILED DESCRIPTION OF EXAMPLE EMBODIMENTS

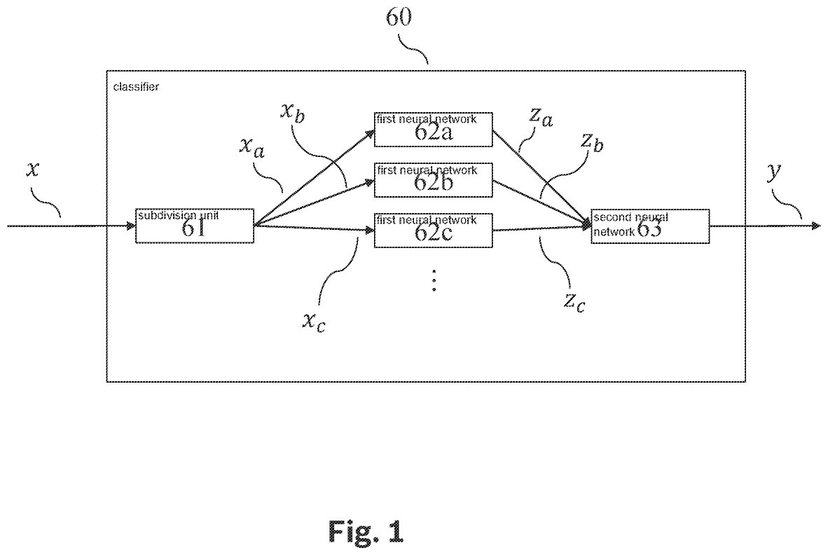

FIG. 1 shows a classifier (60) for classifying a plurality of evaluation points of a molecular biological examination system. A first input signal (x) which characterizes the evaluation points is transmitted to the classifier (60), and the classifier (60) ascertains an output signal (y) with regard to the first input signal (x) that characterizes a classification of the input signal (x). In particular, the first input signal (x) may be an image of an optoelectronic sensor with regard to the evaluation points. The evaluation points are preferably arranged in a rectangular grid.

The evaluation points may especially be evaluation points of a microarray which are able to indicate the presence or absence of certain proteins in the sample through a protein-protein interaction of proteins on the evaluation points with respect to proteins of a biological sample. In this way, it may especially be indicated whether the sample contains specific proteins of a pathogen, e.g., a virus.

The input signal (x) is conveyed to a subdivision unit (61). The subdivision unit breaks down first input signal (x) into a plurality of second input signals (xₐ,x_{b},x_{c}). For this purpose, the subdivision unit can carry out at least one preprocessing step. For example, it is possible that the first input signal (x) is an image, and the subdivision unit first rotates and/or shifts and/or scales the image and then breaks down the preprocessed image into rectangular excerpts.

The breakdown is performed according to a knowledge of subdivision unit (61) about the arrangement of the evaluation points within first input signal (x). For example, the evaluation points may be arranged in the form of a grid, the first input signal (x) being an image of the grid. In this case, subdivision unit (61) may have information available with regard to the structure of the grid. In particular, the subdivision unit may rotate the image in such a way that the evaluation points within the rotated image lie along a horizontal axis and a vertical axis. Next, the image may be broken down along the axes in order to ascertain second input signals (xₐ,x_{b},x_{c}).

Second input signals (xₐ,x_{b},x_{c}) are then conveyed to a first neural network (62a, 62b, 62c), a first neural network (62a, 62b, 62c) being available in classifier (60) for each second input signal (xₐ,x_{b},x_{c}). In alternative exemplary embodiments, it may also be provided that no first neural network is provided for at least one second input signal (xₐ,x_{b},x_{c}) and the second input signal (xₐ,x_{b},x_{c}) is therefore not taken into consideration for the ascertainment of output signal (y).

First neural networks (62a, 62b, 62c) ascertain individual first representations (zₐ,z_{b},z_{c}) based on the second input signals (xₐ,x_{b},x_{c}). The first representations (zₐ,z_{b},z_{c}) are then handed over as input to a second neural network (63). Second neural network (63) then ascertains output signal (y) on the basis of first representations (zₐ,z_{b},z_{c}).

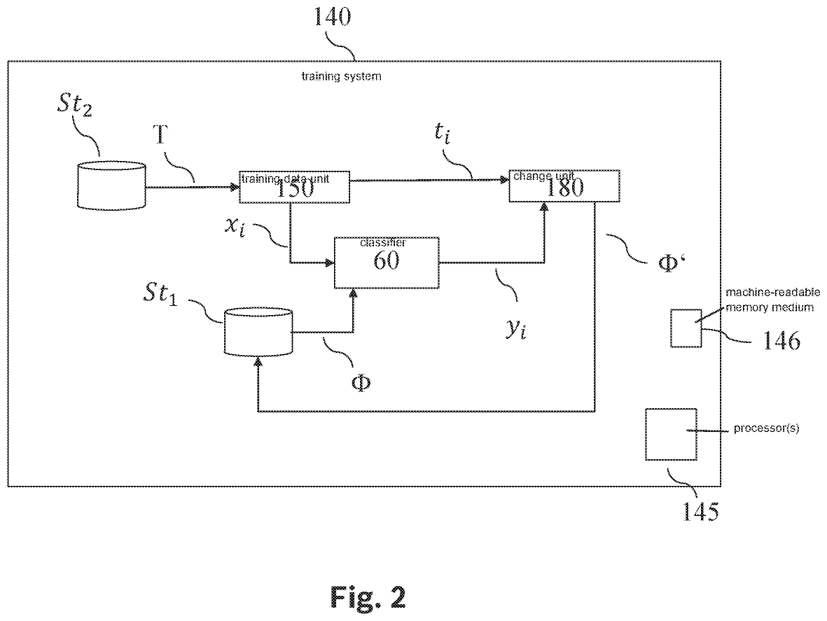

FIG. 2 shows an exemplary embodiment of a training system (140) for training classifier (60) with the aid of a training dataset (T). Training dataset (T) includes a plurality of first input signals (xᵢ), which are used to train classifier (60), training dataset (T) furthermore including a desired output signal (tᵢ) for an input signal (xᵢ) in each case, which corresponds to first input signal (xᵢ) and characterizes a classification of input signal (xᵢ). In particular, a first input signal (xᵢ) may be an image of a plurality of evaluation points of a microarray, while the desired output signal (tᵢ) that corresponds to first input signal (xᵢ) characterizes whether or not at least one pathogen is present in a biological sample that was applied to the evaluation points. If a pathogen is present in a sample, the class of the pathogen is preferably characterized in the desired output signal (tᵢ) as well.

For the training, a training data unit (150) accesses a computer-implemented database (St 2), which makes training dataset (T) available. Preferably, training data unit (150) ascertains, preferably randomly, at least one first input signal (xᵢ) and desired output signal (tᵢ) corresponding to first input signal (xᵢ) from training dataset (T) and conveys first input signal (xᵢ) to the classifier (60). Classifier (60) ascertains an output signal (yᵢ) on the basis of first input signal (xᵢ).

Desired output signal (tᵢ) and the ascertained output signal (yᵢ) are conveyed to a change unit (180).

Based on the desired output signal (tᵢ) and ascertained output signal (yᵢ), change unit (180) then determines new parameters (Φ′) for classifier (60). In the exemplary embodiment, a plurality of weights of the first neural networks (62a, 62b, 62c) and/or a plurality of weights of the second neural network (63) may be understood as parameters (Φ) of classifier (60), for which the change unit ascertains new parameters (Φ′). To this end, change unit (180) compares desired output signal (tᵢ) and ascertained output signal (yᵢ) with the aid of a loss function. The loss function ascertains a first loss value, which characterizes the extent to which ascertained output signal (yᵢ) deviates from desired output signal (tᵢ). In the exemplary embodiment, a negative logarithmized plausibility function (negative log-likehood function), in particular a categorical cross entropy loss, is selected as a loss function. In alternative exemplary embodiments, other loss functions are also possible.

The change unit (180) ascertains the new parameters (Φ′) on the basis of the first loss value. In the exemplary embodiment, this is accomplished with the aid of a gradient descent method, preferably the stochastic gradient descent, Adam, or AdamW.

The ascertained new parameters (Φ′) are stored in a model parameter memory (St₁). The ascertained new parameters (Φ′) are preferably supplied to classifier (60) as parameters (Φ).

In further preferred exemplary embodiments, the described training is iteratively repeatedly or iteratively carried out for a predefined number of iteration steps or iteratively repeated until the first loss value drops below a predefined threshold value. As an alternative or in addition, it is also possible that the training is terminated once an average first loss value with regard to a test or validation dataset drops below a predefined threshold value. In at least one of the iterations, the new parameters (Φ′) determined in a prior iteration are used as parameters (Φ) of the classifier (60).

In addition, training system (140) may include at least one processor (145) and at least one machine-readable memory medium (146), which includes instructions that when executed by a processor (145), induce the training system (140) to execute a training method according to one of the aspects of the present invention.

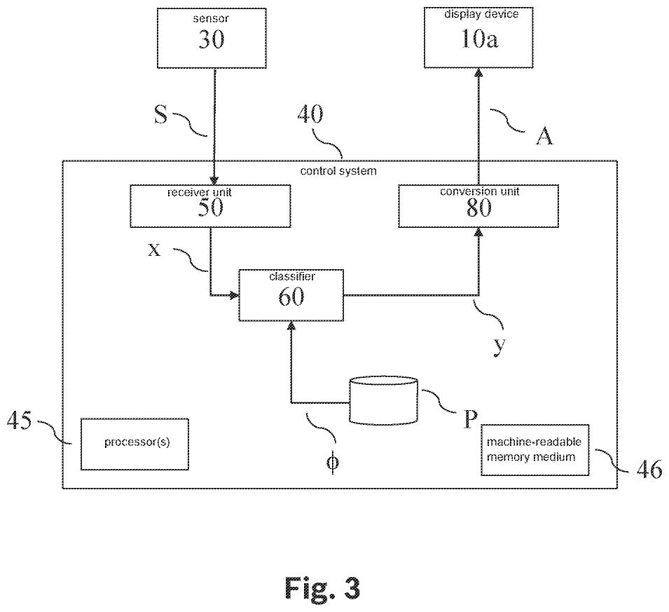

FIG. 3 is a control system (40) of a processing unit for processing biological samples with the aid of the trained classifier (60). An optoelectronic sensor (30), for instance a camera, of the processing unit ascertains a sensor signal (S), which characterizes a plurality of evaluation points.

The control system (40) receives sensor signal (S) from sensor (30) in an optional receiver unit (50), which converts the sensor signal (S) into a first input signal (x) (alternatively, it is also possible to directly accept sensor signal (S) as first input signal (x)). First input signal (x), for example, may be an excerpt or a further processing of sensor signal (S). In other words, first input signal (x) is ascertained as a function of sensor signal (S). First input signal (x) is conveyed to the trained classifier (60).

The classifier (60) is preferably parameterized by parameters (ϕ) which are stored in a parameter memory (P) and are supplied by this memory.

The classifier (60) determines an output signal (y) from first input signal (x). Output signal (y) is conveyed to an optional conversion unit (80), which ascertains an actuation signal (A) therefrom, which is conveyed to a display device (10a) to actuate display device (10a) accordingly.

In further preferred embodiments, control system (40) includes at least one processor (45) and at least one machine-readable memory medium (46) on which instructions are stored that when later executed on the at least one processor (45), induce the control system (40) to carry out the method according to the present invention.

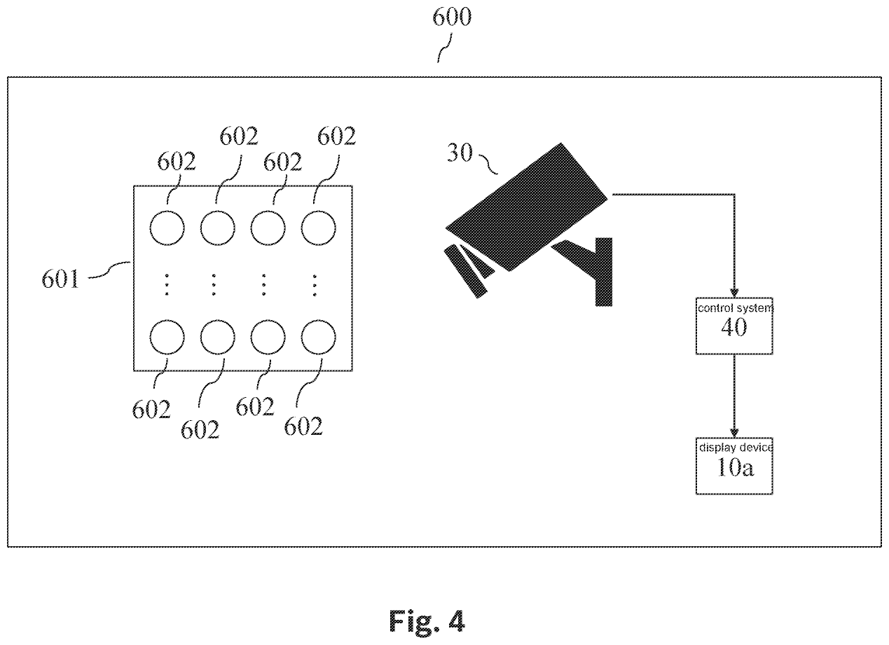

FIG. 4 shows an exemplary embodiment in which control system (40) controls processing unit (600). A microarray (601), which includes a plurality of application points (602) or also test fields, is conveyed to processing unit (600), the test fields having been covered with a biological sample. The sample may come from a swab of a person.

Microarray (601) may especially be a protein microarray. Sensor (30) is designed to record microarray (601). An optoelectronic sensor, in particular, may be used as the sensor (30), preferably a camera. Classifier (60) may thus be understood as an image classifier.

Actuation signal (A) may then be selected in such a way that the result of the classification is displayed on a display of display unit (10a). As an alternative or in addition, it is also possible to output an acoustic signal with the aid of a loudspeaker of display device (10a) if output signal (y) characterizes the presence of at least one pathogen in the sample.

The term ‘computer’ encompasses any devices for processing predefinable arithmetic rules. These arithmetic rules may be available in the form of software or in the form of hardware, or also in a mixed form of software and hardware.

In general, a plurality may be understood as indexed, that is to say, a unique index is assigned to each element of the plurality, preferably by the assignment of consecutive whole numbers to the elements included in the plurality. If a plurality N is included, N being the number of elements in the plurality, the elements are preferably assigned the whole numbers from 1 to N.

1-13. (canceled)

14. A computer-implemented method for training a classifier, the method comprising the following steps:
ascertaining at least one first input signal, the first input signal characterizing a plurality of evaluation points of a molecular biological examination system, and allocating a desired output signal, which characterizes a classification of the evaluation points, to the first input signal;
subdividing the first input signal into a plurality of second input signals according to an arrangement of the evaluation points;
ascertaining a plurality of first representations, a respective first representation being ascertained for each second input signal of at least a first subset of the plurality of second input signals, using the classifier;
ascertaining an output signal using the classifier and based on the plurality of first representations, the output signal characterizing a classification of the first input signal; and
adapting at least one parameter of the classifier according to a loss value, the loss value characterizing a difference between the ascertained output signal and the desired output signal.

15. The method as recited in claim 14, wherein the input signal is ascertained based on a sensor signal of an optoelectronic sensor, the sensor signal characterizing a measurement of the evaluation points.

16. The method as recited in claim 14, wherein the classifier includes at least one first neural network, using which the first representations are ascertained.

17. The method as recited in claim 14, wherein the classifier includes a plurality of first neural networks, the classifier including a respective first neural network for each second input signal of the first subset, using which the first representation of the second input signal is ascertained.

18. The method as recited in claim 14, wherein the output signal is ascertained using a second neural network including the classifier, and based on the first representations.

19. The method as recited in claim 14, wherein the molecular biological examination system includes a microarray, and the input signal characterizes an image of the evaluation points of the microarray.

20. The method as recited in claim 19, wherein each second input signal of the plurality of second input signals is an excerpt of the image, and the excerpt is selected according to the arrangement of the evaluation points of the microarray.

21. A computer-implemented method for ascertaining an output signal, the output signal characterizing a classification of a first input signal, and the first input signal characterizes a plurality of evaluation points of a molecular biological examination system, the method comprising the following steps:
training a classifier, including:
ascertaining at least one third input signal, the third input signal characterizing a plurality of evaluation points of a molecular biological examination system, and allocating a desired output signal, which characterizes a classification of the evaluation points, to the third input signal,
subdividing the third input signal into a plurality of fourth input signals according to an arrangement of the evaluation points,
ascertaining a plurality of third representations, a respective third representation being ascertained for each fourth input signal of at least a first subset of the plurality of fourth input signals, using the classifier,
ascertaining a first output signal using the classifier and based on the plurality of third representations, the output signal characterizing a classification of the third input signal, and
adapting at least one parameter of the classifier according to a loss value, the loss value characterizing a difference between the ascertained first output signal and the desired output signal;
subdividing the first input signal into a plurality of second input signals according to an arrangement of the plurality of evaluation points; and
ascertaining the output signal based on the plurality of second input signals using the classifier.

22. The method as recited in claim 21, wherein a display device is actuated based on the ascertained output signal in such a way that the display device displays the classification.

23. A training device configured for training a classifier, the training device configured to:
ascertain at least one first input signal, the first input signal characterizing a plurality of evaluation points of a molecular biological examination system, and allocate a desired output signal, which characterizes a classification of the evaluation points, to the first input signal;
subdivide the first input signal into a plurality of second input signals according to an arrangement of the evaluation points;
ascertain a plurality of first representations, a respective first representation being ascertained for each second input signal of at least a first subset of the plurality of second input signals, using the classifier;
ascertain an output signal using the classifier and based on the plurality of first representations, the output signal characterizing a classification of the first input signal; and
adapt at least one parameter of the classifier according to a loss value, the loss value characterizing a difference between the ascertained output signal and the desired output signal.

24. A system for data processing for ascertaining an output signal, the output signal characterizing a classification of a first input signal, and the first input signal characterizes a plurality of evaluation points of a molecular biological examination system, the system configured to:
subdivide the first input signal into a plurality of second input signals according to an arrangement of the plurality of evaluation points; and
ascertain the output signal based on the plurality of second input signals using a trained classifier, the classifier being trained by a training device configured to:
ascertain at least one third input signal, the third input signal characterizing a plurality of evaluation points of a molecular biological examination system, and allocate a desired output signal, which characterizes a classification of the evaluation points, to the third input signal,
subdivide the third input signal into a plurality of fourth input signals according to an arrangement of the evaluation points,
ascertain a plurality of third representations, a respective third representation being ascertained for each fourth input signal of at least a first subset of the plurality of fourth input signals, using the classifier,
ascertain a first output signal using the classifier and based on the plurality of third representations, the output signal characterizing a classification of the third input signal, and
adapt at least one parameter of the classifier according to a loss value, the loss value characterizing a difference between the ascertained first output signal and the desired output signal.

25. A non-transitory machine-readable memory medium on is stored a computer program for training a classifier, the computer program, when executed by a computer, causing the computer to perform the following steps:
ascertaining at least one first input signal, the first input signal characterizing a plurality of evaluation points of a molecular biological examination system, and allocating a desired output signal, which characterizes a classification of the evaluation points, to the first input signal;
subdividing the first input signal into a plurality of second input signals according to an arrangement of the evaluation points;
ascertaining a plurality of first representations, a respective first representation being ascertained for each second input signal of at least a first subset of the plurality of second input signals, using the classifier;
ascertaining an output signal using the classifier and based on the plurality of first representations, the output signal characterizing a classification of the first input signal; and
adapting at least one parameter of the classifier according to a loss value, the loss value characterizing a difference between the ascertained output signal and the desired output signal.
